(19) United States
(12) Patent Application Publication
(10) Pub. No.: US 2026/0102762 A1
(43) Pub. Date: Apr. 16, 2026

(54) TRI-(ADAMANTYL)PHOSPHINES AND APPLICATIONS THEREOF

(71) Applicant: The Trustees of Princeton University, Princeton, NJ (US)

(72) Inventors: Brad P. CARROW, Princeton, NJ (US); Liye CHEN, Princeton, NJ (US)

(73) Assignee: The Trustees of Princeton University, Princeton, NJ (US)

(21) Appl. No.: 19/421,980

(22) Filed: Dec. 16, 2025

Related U.S. Application Data
(62) Division of application No. 18/367,813, filed on Sep. 13, 2023, now Pat. No. 12,539,508.
Application No. 18/367,813 is a continuation of application No. 18/100,196, filed on Jan. 23, 2023, now Pat. No. 11,794,180.
Application No. 18/100,196 is a division of application No. 17/167,606, filed on Feb. 4, 2021, now Pat. No. 11,583,844.
Application No. 17/167,606 is a division of application No. 15/770,709, now Pat. No. 10,981,157.
(60) Provisional application No. 62/248,056, filed on Oct. 29, 2015.

(51) Int. Cl. B01J 31/24; B01J 31/22; C07B 37/04; C07F 1/00; C07F 3/00; C07F 9/50; C07F 15/00

(52) U.S. Cl. CPC B01J 31/2485; B01J 31/2208; B01J 31/2295; B01J 31/2447; C07B 37/04; C07F 9/5018; C07F 9/5045; C07F 15/0006; C07F 15/006; C07F 15/0066; C07F 15/0073; B01J 2231/14; B01J 2231/4205; B01J 2231/4211; B01J 2231/4227; B01J 2231/4233; B01J 2231/4261; B01J 2231/4272; B01J 2231/4283; B01J 2531/0205; B01J 2531/0288; B01J 2531/822; B01J 2531/824; B01J 2540/442; C07F 1/00; C07F 3/00

(57) ABSTRACT

In one aspect, phosphine compounds comprising three adamantyl moieties (PAd₃) and associated synthetic routes are described herein. Each adamantyl moiety may be the same or different. For example, each adamantyl moiety (Ad) attached to the phosphorus atom can be independently selected from the group consisting of adamantane, diamantane, triamantane and derivatives thereof. Transition metal complexes comprising PAd₃ ligands are also provided for catalytic synthesis including catalytic cross-coupling reactions.

### RELATED APPLICATION DATA

The present application is a divisional application of U.S. patent application Ser. No. 18/367,813 filed Sep. 13, 2023, which is a continuation application of U.S. patent application Ser. No. 18/100,196 filed Jan. 23, 2023, now U.S. Pat. No. 11,794,180, which is a divisional application of U.S. patent application Ser. No. 17/167,606 filed Feb. 4, 2021, now U.S. Pat. No. 11,583,844, which is a divisional application of U.S. patent application Ser. No. 15/770,709 filed Apr. 24, 2018, now U.S. Pat. No. 10,981,157, which is a U.S. National Phase of PCT/US16/59698 filed Oct. 31, 2016, which claims priority pursuant to 35 U.S.C. § 119(e) to U.S. Provisional Patent Application Ser. No. 62/248,056 filed Oct. 29, 2015, each of which is hereby incorporated by reference in its entirety.

### FIELD

The present invention relates to phosphine compounds comprising three adamantyl moieties (PAd₃) and, in particular, to transition metal complexes incorporating PAd₃ ligand for cross-coupling catalysis.

### BACKGROUND

Modern synthetic organic methods utilizing homogeneous transition metal catalysis have benefited immensely from the capacity of phosphines to modify the activity, selectivity and stability of metal catalysts. As a corollary, the behavior of metal catalysts can be manipulated by tuning the steric and electronic properties of supporting ligands such as phosphines. Thus, the discovery of novel phosphine structures with steric and/or electronic properties beyond what can be accessed using existing phosphorus-based ancillary ligands is desirable. Newer applications of phosphines to organocatalysis, frustrated Lewis pair (FLP) catalysis, biorthogonal reactions, and nano-materials should also benefit from access to new phosphine properties.

### SUMMARY

In one aspect, phosphine compounds comprising three adamantyl moieties (PAd₃) and associated synthetic routes are described herein. Each adamantyl moiety may be the same or different. For example, each adamantyl moiety (Ad) attached to the phosphorus atom can be independently selected from the group consisting of adamantane, diamantane, triamantane and derivatives thereof. Therefore, a series of PAd₃ compounds are contemplated. In another aspect, a method of synthesizing a PAd₃ compound comprises providing a reaction mixture including di-(adamantyl)phosphine (PAd₂) and a substituted adamantyl moiety and reacting the PAd₂ and substituted adamantyl moiety via an S_{N}1 pathway to provide PAd₃. In other embodiments, a method of synthesizing a PAd₃ compound comprises providing a reaction mixture including di-(adamantyl)phosphide and a substituted adamantyl moiety and reacting the di-(adamantyl)phosphide and substituted adamantyl moiety via an S_{N}1 pathway to provide PAd₃.

In another aspect, metal complexes are provided. A metal complex comprises at least one transition metal and one or more PAd₃ ligands described herein coordinated to the transition metal. In some embodiments, a metal complex is of the formula (PAd₃)ₘM(L)ₙ wherein M is the transition metal, L is ligand and m and n are each integers from 1 to 3.

In a further aspect, methods of catalysis are described herein, including catalytic cross-coupling reactions. A method of cross-coupling, in some embodiments, comprises providing a reaction mixture including a substrate, a coupling partner and a transition metal complex comprising PAd₃ ligand and reacting the substrate and coupling partner in the presence of the transition metal complex or derivative thereof to provide cross-coupled reaction product. In some embodiments, the substrate can be selected from substituted aromatic compounds or substituted unsaturated aliphatic compounds. Moreover, the coupling partner can comprise a variety of species including, but not limited to, organoboron compounds, organolithium compounds, organozinc compounds, organosilicon compounds, Grignard reagents and/or compounds having labile C—H bonds.

These and other embodiments are further described in the detailed description which follows.

### BRIEF DESCRIPTION OF THE DRAWINGS

FIG. 1(a) illustrates various PAd₃ compounds according to some embodiments.

FIG. 1(b) illustrates various salt forms of the PAd₃ compounds of FIG. 1(a) according to some embodiments.

FIG. 2 illustrates synthesis of one embodiment of a PAd₃ compound described herein.

FIG. 3 illustrates several transition metal complexes incorporating PAd₃ ligands according to some embodiments.

FIG. 4 illustrates several transition metal complexes incorporating PAd₃ ligands according to some embodiments.

FIG. 5(a) illustrates various phenol leaving groups of aryl substrates according to some embodiments.

FIG. 5(b) illustrates various thiophenol leaving groups of aryl substrates according to some embodiments.

FIG. 6 illustrates Suzuki-Miyaura coupling with transition metal complex described herein according to some embodiments.

FIG. 7 illustrates coupling partner compounds (R′—H) having reactive C—H bonds according to some embodiments.

FIG. 8 illustrates Suzuki-Miyaura polymerization with transition metal complex described herein according to some embodiments.

FIG. 9 illustrates Kumada-Tamao-Corriu coupling with transition metal complex described herein according to some embodiments.

FIG. 10 illustrates Buchwald-Hartwig amination with transition metal complex described herein according to some embodiments.

FIG. 11 illustrates α-arylation with transition metal complex described herein according to some embodiments.

FIG. 12 illustrates cross-coupling with transition metal complex described herein according to some embodiments.

FIG. 13 illustrates one embodiment of a transition metal catalyst described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### Definitions

The term “alkyl” as used herein, alone or in combination, refers to a straight or branched saturated hydrocarbon group optionally substituted with one or more substituents. For example, an alkyl can be C₁-C₃₀.

The term “alkenyl” as used herein, alone or in combination, refers to a straight or branched chain hydrocarbon group having at least one carbon-carbon double bond.

The term “aryl” or “arene” as used herein, alone or in combination, refers to an aromatic monocyclic or multicyclic ring system optionally substituted with one or more ring substituents

The term “heteroaryl” or “heteroarene” as used herein, alone or in combination, refers to an aromatic monocyclic or multicyclic ring system in which one or more of the ring atoms is an element other than carbon, such as nitrogen, oxygen and/or sulfur.

The term “alkoxy” as used herein, alone or in combination, refers to the moiety RO—, where R is alkyl, alkenyl or aryl defined above.

The term “fluoroalkyl” as used herein refers to an alkyl group defined above wherein one or more hydrogen atoms are replaced by fluorine atoms.

### I. PAd₃ Compounds

In one aspect, phosphine compounds comprising three adamantyl moieties (PAd₃) and associated synthetic routes are described herein. Each adamantyl moiety may be the same or different. For example, each adamantyl moiety (Ad) attached to the phosphorus atom can be independently selected from the group consisting of adamantane, diamantane, triamantane and derivatives thereof. In some embodiments, for example, all the adamantyl moieties (Ad) may be the same. In other embodiments, all adamantyl moieties (Ad) may be different. In further embodiments, two adamantyl moieties (Ad) may be the same while the third adamantyl moiety (Ad) is different. Accordingly, use of the common abbreviation Ad for adamantyl moieties of PAd₃ compounds is not to be construed as imparting any structural similarity or difference between the three adamantyl moieties.

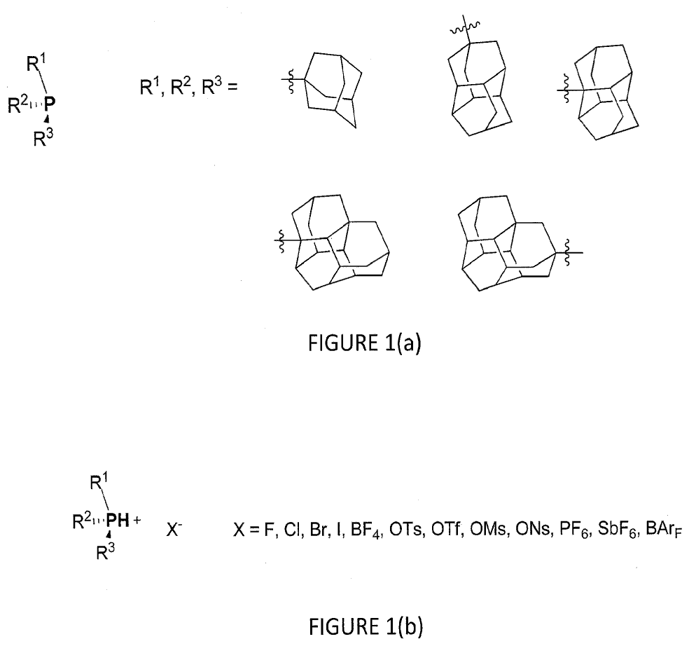

FIG. 1(a) illustrates various PAd₃ compounds according to some embodiments described herein. As illustrated in FIG. 1, R¹, R² and R³ can be independently selected from several adamantyl moieties (Ad) to provide a series of PAd₃ compounds of differing structure. In some embodiments, adamantyl moieties (Ad) of PAd₃ compounds are substituted at one or more positions. Adamantyl moieties, for example, can include one or more acyl-, aryl-, alkyl-, alkoxy-, alkyl-amine and/or alcohol substituents. PAd₃ compounds can also exist in salt form as illustrated in FIG. 1(b).

Synthetic routes for PAd₃ compounds are also described herein. In one aspect, a method of synthesizing a PAd₃ compound comprises providing a reaction mixture including di-(adamantyl)phosphine (PAd₂) and a substituted adamantyl moiety and reacting the PAd₂ and substituted adamantyl moiety via an S_{N}1 pathway to provide PAd₃. Adamantyl moieties of PAd₂ can be independently selected from adamantane, diamantane, triamantane and derivatives thereof. Similarly, the substituted adamantyl moiety can have an adamantane, diamantane or triamantane architecture. In one non-limiting embodiment, the PAd₃ compound illustrated in structure of formula (I) below is synthesized according to the foregoing method.

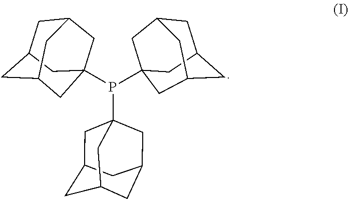 [SMILES: C1C2CC3CC1CC(P(C14CC5CC(CC(C5)C1)C4)C14CC5CC(CC(C5)C1)C4)(C2)C3]

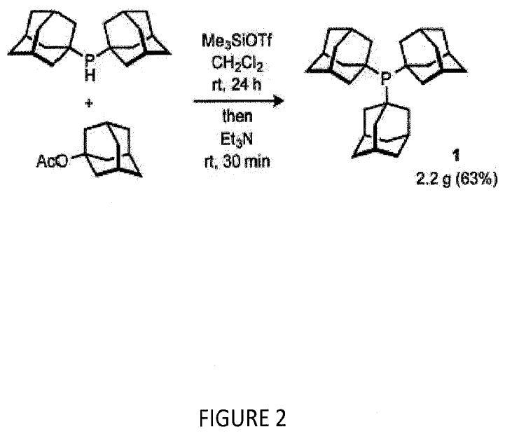

A reaction mixture including di-1-adamantylphosphine and a substituted adamantane is provided. The di-1-adamantylphosphine and substituted adamantane are reacted via an S_{N}1 pathway to provide tri(1-adamantyl)phosphine. The substituted adamantane, in some embodiments, is of formula (II)

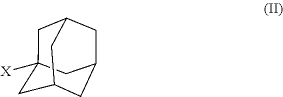

wherein X is a moiety operable for dissociation into an anion under the S_{N}1 pathway. In some embodiments, for example, X is selected from the group consisting of acetate, triflate, tosylate and hydroxyl. FIG. 2 provides specific reaction conditions of the S_{N}1 route for synthesis of the PAd₃ compound of formula (I) according to one embodiment. Diamantane and triamantane moieties can also be functionalized with a leaving group to provide substituted adamantane for reaction with PAd₂ via an S_{N}1 pathway. The leaving group of these higher adamantane structures can also be selected from the group consisting of acetate, triflate, tosylate and hydroxyl.

In other embodiments, a method of synthesizing PAd₃ compounds described herein comprises providing a reaction mixture including di-(adamantyl)phosphide and a substituted adamantyl moiety and reacting the di-(adamantyl)phosphide and substituted adamantyl moiety via an S_{N}1 pathway to provide PAd₃. Suitable substituted adamantyl moiety can include a leaving group, X, as described above. Moreover, suitable counterions of the phosphide, in some embodiments, are cations of bases used to deprotonate PAd₂ and can include alkali ions, MgCl⁺ and ZnBr⁺. Moreover, strong amine bases for which the pKa (H₂O) of the amine conjugate acid exceeds approximately 10 may be employed as counterions. Such species can include tertiary ammonium ions

It is particularly noted that PAd₃ compounds of the present disclosure exhibit significant kinetic stability toward oxidation, thereby permitting storage under air with negligible oxidation. Additionally, synthetic methods described herein can provide PAd₃ compounds at yields exceeding 50 percent or 60 percent.

### II. Metal Complexes

In another aspect, metal complexes are provided. A metal complex comprises at least one transition metal and one or more PAd₃ compounds described in Section I above as ligand coordinated to the transition metal. Any transition metal operable to coordinate with phosphine ligands can be used to provide a metal complex described herein. In some embodiments, the transition metal is selected from Group VIIIA, IB or IIB of the Periodic Table. Groups of the Periodic Table described herein are identified according to the CAS designation. Further, the transition metal can be a noble metal including, but not limited to, palladium, rhodium, silver and gold. In some embodiments, the metal complex comprises two transition metals, wherein PAd₃ ligands are coordinated to one or each of the transition metals. Non-PAd₃ ligands bridging the transition metal centers can include halo, η³-allyl, η³-crotyl, η³-cinnamyl and η³-indenyl.

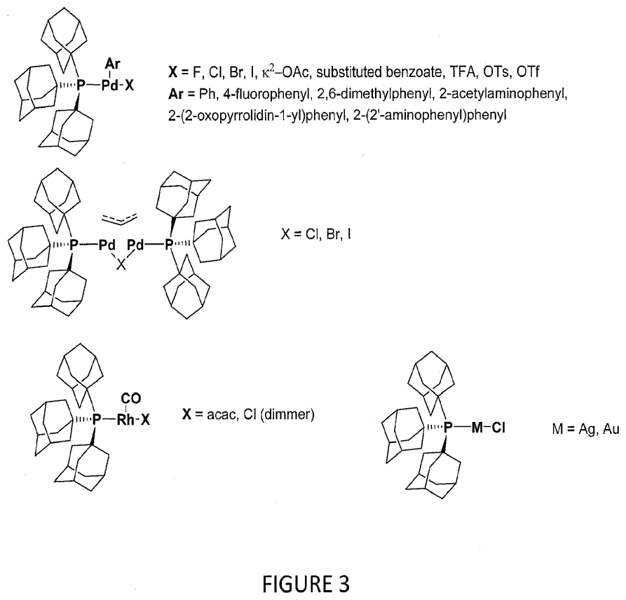

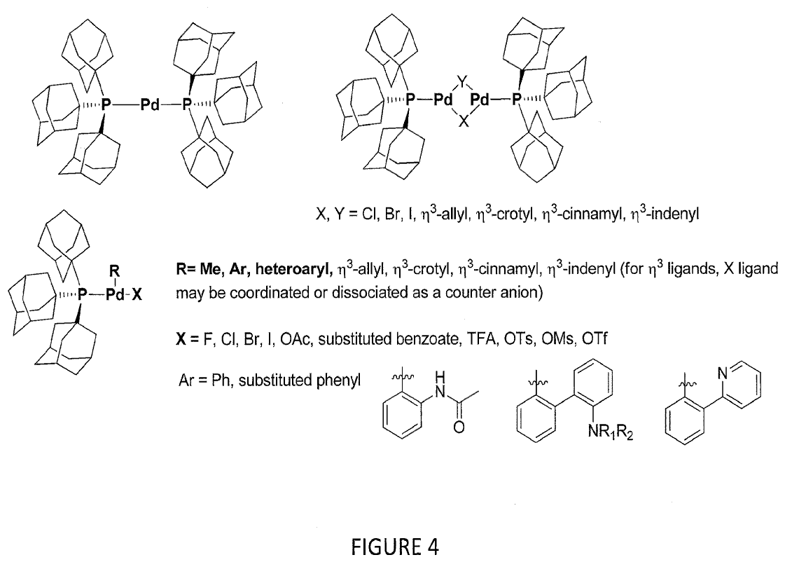

Moreover, the metal complex can be of the formula (PAd₃)ₘM(L)ₙ wherein M is the transition metal, L is ligand and m and n are each integers from 1 to 3. L can generally comprise any species meeting the steric requirements set by the PAd₃ ligand(s). In some embodiments, for example, L can be selected from the group consisting of alkyl, aryl, halo, CO, cyano, hydroxyl, acetate, substituted benzoate, trifluoroacetate (TFA), tosylate (OTs), mesylate (OMs), triflate (OTf), η³-allyl, η³-crotyl, η³-cinnamyl and η³-indenyl. In embodiments wherein n is greater than 1, the chemical identity of L ligands can be the same or different. FIGS. 3 and 4 illustrate non-limiting examples of metal complexes employing PAd₃ ligands described herein. The adamantyl moieties (Ad) of the metal complexes illustrated in FIGS. 3 and 4 are adamantane. It is contemplated that any combination of adamantane, diamantane and/or triamantane moieties can be present in PAd₃ ligands of the metal complexes.

### III. Catalytic Cross-Coupling

In a further aspect, methods of catalysis are described herein, including catalytic cross-coupling reactions. A method of cross-coupling, in some embodiments, comprises providing a reaction mixture including a substrate, a coupling partner and a transition metal complex comprising PAd₃ ligand and reacting the substrate and coupling partner in the presence of the transition metal complex or derivative thereof to provide cross-coupled reaction product. The transition metal complex can have any composition and/or properties described in Section II hereinabove.

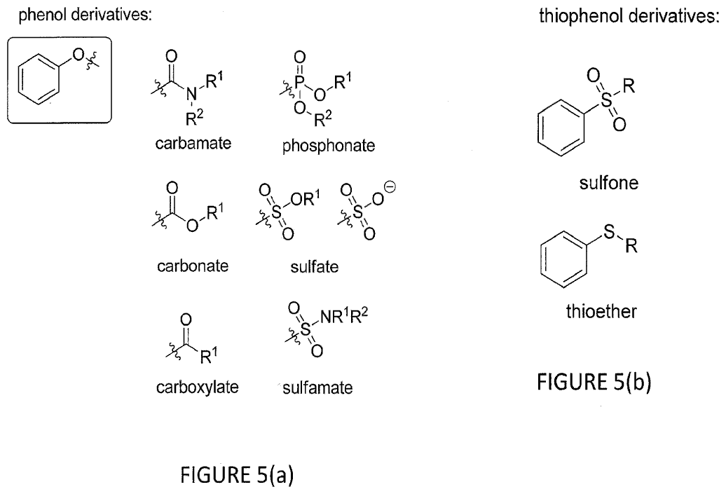

The substrate can generally be selected from substituted aromatic compounds or substituted unsaturated aliphatic compounds. Suitable substituted aromatic compounds can include monocyclic and multicyclic ring systems, such as fused and non-fused multicyclic ring systems. Substituted aryl compounds can also comprise heteroaryl species, including monocyclic and multicyclic heteroaryl systems. Multicyclic heteroaryl systems can comprise fused and non-fused ring structures such as fused or non-fused heteroaryl rings as well as heteroaryl rings fused or non-fused to aryl rings. A substituted aromatic compound of the reaction mixture comprises a leaving group. Any leaving group operable to undergo cross-coupling mechanistic pathways described herein can be employed. A leaving group, in some embodiments, is selected from the group consisting of halo, tosylate (OTs), mesylate (OMs), nosylate (ONs), N₂⁺X⁻, N₂NR¹R² and NMe₃⁺, wherein X⁻ is halide and R¹ and R² are alkyl. In additional embodiments, a leaving group can be based on phenol derivatives of the aromatic compound including, but not limited to, carbamates, phosphonates, carbonates, sulfates, carboxylates and sulfamates. FIG. 5(a) illustrates various phenol derivative leaving groups according to some embodiments. R¹ and R² in the embodiments of FIG. 5(a) can be alkyl or other suitable aliphatic or substituted aliphatic group. FIG. 5(b) illustrates thiophenol derivative leaving groups, wherein R can be alkyl or other suitable aliphatic or substituted aliphatic group.

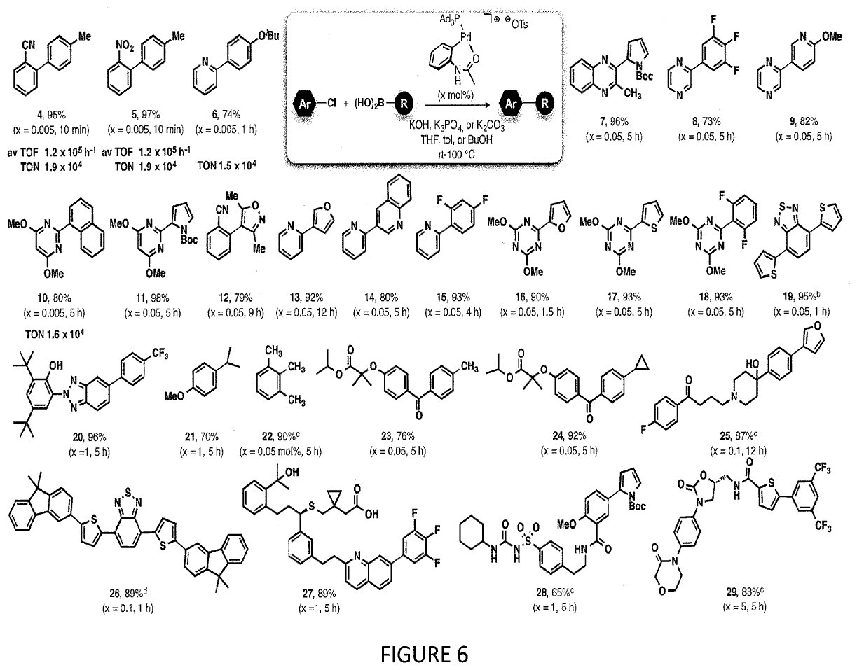

Aromatic substrates can also comprise one or more ring substituents in addition to the leaving group. As illustrated in the non-limiting embodiments of FIG. 6 and the examples below, aromatic substrates can comprise one or more ring substituents selected from the group consisting of alkyl, cycloalkyl, alkoxy, acyl, nitro, nitrile, hydroxyl and amide.

Substrates of cross-coupling reactions described herein also include substituted unsaturated aliphatic compounds. Substituted unsaturated aliphatic compounds can exhibit a single point of unsaturation, such as in vinyl or allyl compounds. In other embodiments, substituted unsaturated aliphatic compounds can have more than one point of unsaturation. As with aromatic substrates, substituted aliphatic compounds comprise a leaving group. For example, a substituted unsaturated aliphatic compound can comprise any of the leaving groups described above for substituted aromatic compounds. In some embodiments, a leaving group is attached to allyl or vinyl moieties to provide substituted unsaturated aliphatic substrate. In such embodiments, the vinyl or allyl group can include one or more substituents in addition to the leaving group, including alkyl and/or acyl substituents.

The coupling partner of the reaction mixture can comprise a variety of species including, but not limited to, organoboron compounds, organolithium compounds, organozinc compounds, organosilicon compounds and Grignard reagents. Organic moieties of these organometallic compounds can comprise aromatic moieties and aliphatic moieties. Suitable aryl moieties can include monocyclic and multicyclic ring systems, such as fused and non-fused multicyclic ring systems. Aryl moieties can also comprise heteroaryl species, including monocyclic and multicyclic heteroaryl systems. Multicyclic heteroaryl systems can comprise fused and non-fused ring structures such as fused or non-fused heteroaryl rings as well as heteroaryl rings fused or non-fused to aryl rings. In some embodiments, aromatic moieties comprise one or more ring substituents selected from the group consisting of alkyl, cycloalkyl, fluoroalkyl and halo.

Suitable aliphatic moieties of organometallic coupling partners include unsaturated moieties, such as vinyl or allyl groups, as well as saturated moieties. In some embodiments, for example, an unsaturated carbon is coupled to the metal or metalloid of the organometallic compound. In other embodiments, a branch point carbon of a saturated aliphatic moiety is coupled to the metal or metalloid of the organometallic compound. Alternatively, a non-branch point carbon of a saturated aliphatic moiety can be coupled to the metal or metalloid of the organometallic compound.

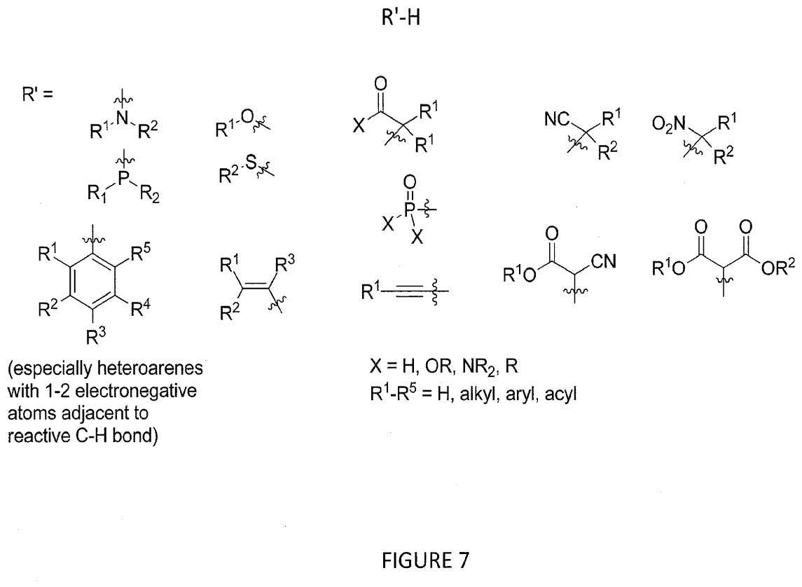

In further embodiments, a coupling partner comprises a compound having a labile C—H bond. Compounds having reactive C—H bonds, in some embodiments, comprise amines, phosphines, phosphonates, aliphatic carboxylic acids and esters, aliphatic dicarboxylic acids and esters, ketones, nitriles, nitroalkanes, unsaturated aliphatic compounds and aromatic compounds, including aryl and heteroaryl compounds. Heteroarenes can be especially reactive when one or two electronegative atoms are adjacent to the labile C—H bond. FIG. 7 illustrates various non-limiting embodiments of coupling partner compounds comprising reactive C—H bonds.

When employing organoboron coupling partner, cross-coupling reactions described herein can proceed via Suzuki-Miyaura coupling or Suzuki-Miyaura polycondensation. FIG. 6 illustrates a number of Suzuki-Miyaura couplings employing transition metal complex described herein as catalyst. The cross-couplings illustrated in FIG. 6 are discussed in further detail in the examples below. Table I lists additional catalytic schemes and associated figures employing transition metal catalyst described herein.

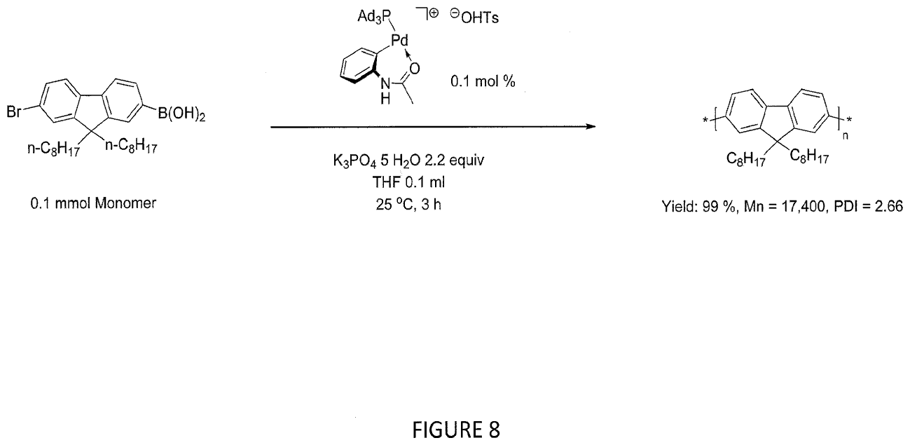

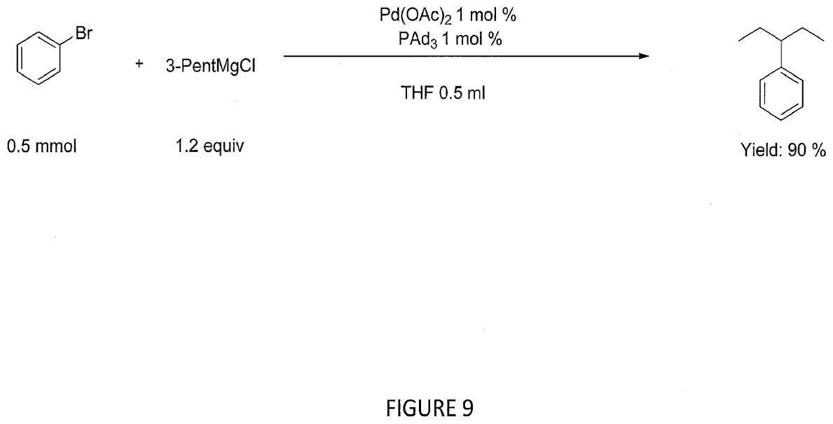

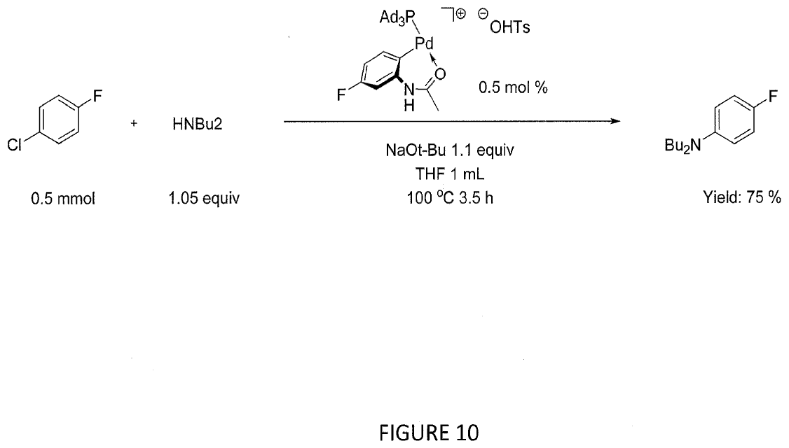

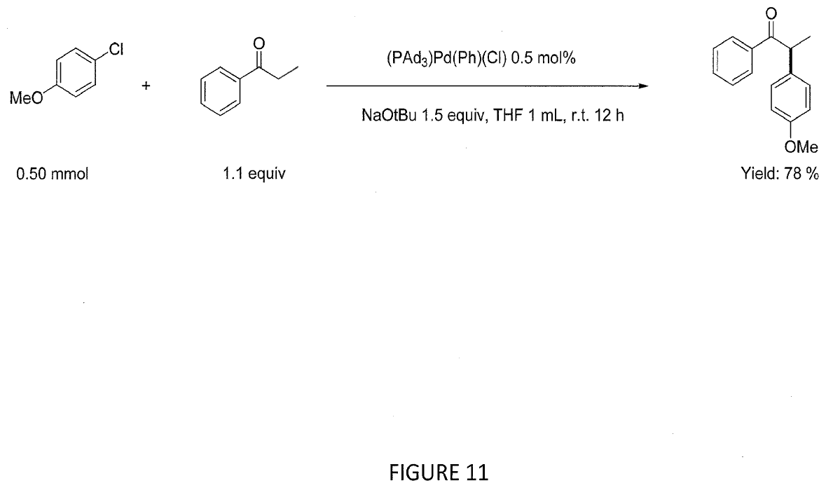

TABLE I
Cross Coupling Reactions

| Coupling Partner | Catalytic Scheme | Example |
|---|---|---|
| 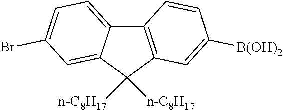 | Suzuki-Miyaura polymerization | FIG. 8 |
| Grignard Reagent | Kumada-Tamao-Corriu | FIG. 9 |
| (R—Mg—X) | coupling | |
| Alkyl amine/aryl amine | Buchwald-Hartwig amination | FIG. 10 |
| Carbonyl species-ketone, | α-arylation | FIG. 11 |
| ester, amide, imide | | |

Transition metal complex can be present in the reaction mixture in any amount not inconsistent with objectives of the present invention. Generally, transition metal complex can be present in an amount of 0.005-5 mol %. Transition metal complex can also be present in the reaction mixture in an amount selected from Table II.

TABLE II
Transition Metal Complex Loading (mol. %)
0.01-3
0.01-1
0.01-0.5
0.01-0.25
0.01-0.1
≤0.5
≤0.1

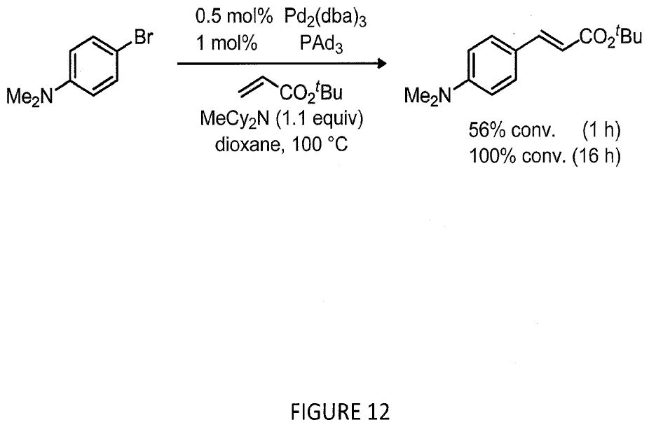

In some embodiments, transition metal complex described herein is formed prior to addition to the reaction mixture. Alternatively, PAd₃ ligand and transition metal complex precursor are added to the reaction mixture for in-situ formation of the catalytic transition metal complex or derivative thereof. FIGS. 9 and 12, for example, illustrate addition of PAd₃ ligand and transition metal complex precursor to the reaction mixture for catalytic cross-coupling of substrate and coupling partner.

Cross-coupling methods described herein can exhibit product yields greater than 50 percent. In some embodiments, product yield ranges from 60-99 percent. Cross-coupling methods described herein can also exhibit product yields selected from Table III.

TABLE III
Product Yield (%)
70-99
75-99
80-99
90-99
95-99
>90

Further, transition metal complex described herein can exhibit high turnover numbers (TON) and high turnover frequencies (TOF). For example, transition metal complex, in some embodiments, displays TON of at least 1.5×10⁴ and TOF of at least 1×10⁵ h⁻¹.

These and other embodiments are further illustrates by the following non-limiting examples.

### General Methods

All reactions were conducted inside a dry nitrogen filled glove box or using standard Schlenk techniques unless otherwise noted. Solvents were purchased from Aldrich or Fisher and purified in a solvent purification system by percolation through neutral alumina under positive pressure of nitrogen. All chemical reagents were used as received from Aldrich, Combi-Blocks, and TCI unless otherwise noted. Tribasic potassium phosphate granular powder purchased from Fisher was nominally determined to be ca. K₃PO₄·5H₂O according to mass loss measurement after drying at 65° C. for 10 h in a vacuum oven, though this is likely an admixture of the known hydrates K₃PO₄·3H₂O and K₃PO₄·7H₂O. Tribasic potassium phosphate monohydrate was purchased from Aldrich and ground with a mortar and pestle prior to use. Potassium hydroxide was purchased from EMD Millipore and ground with a mortar and pestle prior to use. Bis-{2-[(acetyl-κO)amino]phenyl-κC}bis[μ-(p-toluenesulfonate)]dipalladium was prepared according to literature procedure.

All products are purified with forced-flow chromatography on Teledyne IscoRediSep® prepacked silica gel columns. Infrared spectra (FT-IR) were obtained in dichloromethane solution on a Thermo Nicolet spectrometer for Rh(acac)(CO)(L) complexes. ¹H, ¹³C{¹H}, ³¹P{¹H}nuclear magnetic resonance spectra (NMR) were obtained on a Bruker 300 MHz or 500 MHz spectrometer and values reported in ppm (δ) referenced against residual CHCl₃, CHDCl₂, etc. Spin-spin coupling constants are described as singlet (s), doublet (d), triplet (t), quartet (q), quintet (quint), broad (br) or multiplet (m), with coupling constants (J) in Hz. High resolution mass spectrometry (HR-MS) data were obtained using an Agilent 6210 High Resolution Electrospray TOF-MS.

### Example 1—Preparation of tri(1-adamantyl)phosphine

An oven-dried 100 ml round-bottomed flask equipped with a magnetic stir bar was charged with di-1-adamantylphosphine (2.35 g, 7.77 mmol, 1.0 equiv) and 1-adamantylacetate (1.66 g, 8.54 mmol, 1.1 equiv) in the glove box. dichloromethane (40 ml) was added to dissolve the entire solid. The flask was capped with a rubber septum, and taken out of the glove box. Me₃SiOTf (1.69 ml, 9.32 mmol, 1.2 equiv) was added by syringe and the reaction mixture was stirred at room temperature for 24 h. Triethylamine (5.4 ml, 39 mmol, 5.0 equiv) was then added and the reaction was stirred for an additional 0.5 h at room temperature. The neutralized PAd₃ subsequently precipitated from solution and was isolated by simple filtration on a disposable filter funnel followed by rinsing with ethanol (50 ml). After aspiration for 0.5 h, 2.2 g (63%) of 1 obtained as a pure white powder. Although a solution of PAd₃ is prone to oxidation under air, material in the solid state can be stored on the bench top for at least three months without substantial decomposition. Note that slow decompose in chlorinated solvent (dichloromethane, chloroform) was observed even under an inert atmosphere, but the compound appears stable in solutions of THF, benzene and toluene under N₂.

¹H NMR (501 MHz, CD₂Cl₂) δ 2.13 (br, 18H), 1.84 (br, 9H), 1.74-1.58 (m, 18H).

¹³C NMR (126 MHz, CD₂Cl₂) δ 42.68 (br), 41.10 (d, J=34.3 Hz), 37.0, 29.5 (d, J=7.2 Hz).

³¹P NMR (121 MHz, C₆D₆) δ 59.35.

HRMS (ESI) m/z calculated for C₃₀H₄₆PO (M+17) 453.3286, found 453.3289.

### Example 2—Preparation of Rh(acac)(CO)(PAd₃)

PAd₃ (22 mg, 50 mmol, 1 equiv) and Rh(acac)(CO)₂ (12.9 mg, 50 mmol, 1 equiv) were dissolved in THF (2 mL) inside the glove box and stirred for 12 h. After evaporation of solvent and purification of the residue by flash chromatography (90% hexane, 10% ethyl acetate) and drying of the resulting solid under vacuum, 10.5 mg (32%) of the metal complex was obtained as yellow powder.

¹H NMR (300 MHz, CDCl₃) δ 5.52 (s, 1H), 2.62 (br, 18H), 2.08 (s, 3H), 2.08-1.98 (br, 9H), 1.94 (s, 3H), 1.90-1.62 (m, 18H).

¹³C {¹H} NMR (126 MHz, CDCl₃) δ 192.9 (dd, J=76.8, 19.3 Hz), 188.1, 184.0, 100.9 (d, J=2.5 Hz), 48.2 (d, J=7.3 Hz), 42.3 (br), 36.8 (br), 29.6 (d, J=7.6 Hz), 27.7 (d, J=4.6 Hz), 27.1.

³¹P{¹H} NMR (121 MHz, CDCl₃) δ 90.6 (d, J=174.6 Hz).

### Example 3—Preparation of Catalyst {2-[(acetyl-κO)amino)phenyl-κC](tri-1-adamantylphosphine)palladium}⁺ (p-toluenesulfonate)⁻

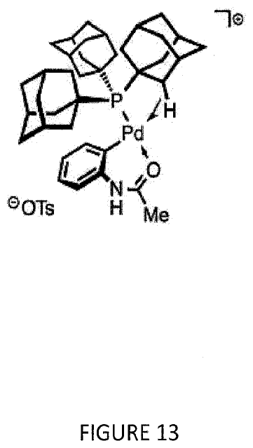

Tri(1-adamantyl)phosphine (44 mg, 0.1 mmol, 1 equiv) and bis-{2-[(acetyl-κO)amino]phenyl-κC}bis[μ-(4-methylbenzenesulfonate)]dipalladium (41 mg, 0.05 mmol, 0.5 equiv) were weighed into a 20 ml scintillation vial with a magnetic stir bar and brought into glove box. THF (4 ml) was added to the solid. The reaction mixture was stirred at room temperature for 20 min, then concentrated to ca. 1 ml and diluted with diethyl ether (15 ml). The resulting solid that formed was isolated by filtration then dried under vacuum to afford 75 mg (88%) of catalyst as a yellow powder. Catalyst structure is illustrated in FIG. 13. Crystals suitable for single crystal X-ray diffraction were grown from a THF solution at room temperature.

¹H NMR (501 MHz, CD₂Cl₂) δ 12.32 (s, 1H), 7.80 (d, J=7.8 Hz, 2H), 7.52-7.41 (m, 2H), 2.35-2.31 (m, 1H), 7.18 (m, 3H), 6.89-6.82 (m, 1H), 2.49 (s, 3H), 2.45 (br, 18H), 2.40 (s, 3H), 2.11 (br, 9H), 1.84 (br, 18H).

³¹P NMR (203 MHz, CD₂Cl₂) δ 47.24.

¹³C NMR (126 MHz, CD₂Cl₂) δ 169.73 (d, J=2.3 Hz), 144.09, 142.19 (d, J=10.0 Hz), 139.32, 132.65 (d, J=1.6 Hz), 128.53, 127.43, 125.84, 123.40 (d, J=5.6 Hz), 120.77, 117.77 (d, J=6.6 Hz), 48.36 (d, J=6.2 Hz), 41.56, 36.08, 29.04 (d, J=7.7 Hz), 21.04 (d, J=3.5 Hz), 20.99.

### Example 4—Preparation of Pd(PAd₃)(Ph)(κ²-OAc)

Pd(py)₂(Ph)(I) (28 mg, 0.060 mmol, 1 equiv), prepared according to Grushin's protocol,⁶ and silver acetate (10 mg, 0.060 mmol, 1 equiv) were stirred in toluene (0.5 mL). After 1.5 h the mixture was filtered through a Celite plug and concentrated to 1 mL. PAd₃ (20 mg, 0.046 mmol, 1 equiv) was then added to the solution and stirred for 10 min. The resulting mixture was evaporated, redissolved in toluene (0.5 mL), and diluted with ether (10 mL). After sonication, the resulting solid was collected by filtration and aspirated for 0.5 h, yielding 23 mg (57%) of the metal complex as a yellow powder.

¹H NMR (501 MHz, CD₂Cl₂) δ 7.30 (d, J=7.9 Hz, 2H), 6.82 (t, J=7.3 Hz, 2H), 6.77 (t, J=7.1 Hz, 1H), 2.42 (br, 18H), 1.86 (br, 9H), 1.79 (s, 3H), 1.72-1.52 (m, 18H).

¹³C{¹H} NMR (126 MHz, CD₂Cl₂) δ 186.9, 141.0, 135.8 (d, J=3.0 Hz), 126.9, 123.5, 49.1 (d, J=6.8 Hz), 42.3, 36.4, 29.4 (d, J=7.9 Hz), 23.6.

³¹P{¹H} NMR (203 MHz, CD₂Cl₂) δ 68.2.

HRMS (ESI) m/z calculated for Pd(PAd₃)(Ph)(MeCN) cation C₃₈H₅₃NPPd 660.2950, found 660.2944.

### Example 5—Preparation of SePAd₃

PAd₃ (11 mg, 25 mol, 1 equiv) and selenium (9 mg, 95 mol, 3.8 equiv) were dissolved in THF (2 mL) inside the glove box and stirred for 1 h. After removal of excess selenium by decantation, the mother liquor was evaporated under vacuum to yield 13 mg (99%) of SePAd₃ as a white powder.

¹H NMR (501 MHz, CDCl₃) δ 2.41 (br, 18H), 1.97 (br, 9H), 1.79-1.33 (m, 18H).

¹³C{¹H} NMR (126 MHz, CDCl₃) δ 48.15 (d, J=19.6 Hz), 40.14 (br), 36.53 (br), 29.17 (d, J=8.5 Hz).

³¹P{¹H} NMR (203 MHz, CDCl₃) δ 79.69 (s, ¹J_{P-Se}=669.9 Hz).

### Examples 6-44: Suzuki-Miyaura Coupling and Characterization of Products

The following products were prepared via Suzuki-Miyaura with PAd₃ metal catalyst. As described in the procedures below, the PAd₃ metal catalyst was generated in situ by addition of a THF stock solution of bis-{2-[(acetyl-κO)amino]phenyl-κC}bis[μ-(p-toluenesulfonate)]dipalladium (3) and PAd₃ ligand. The catalyst formed in situ is described and characterized in Example 3 and illustrated in FIG. 13.

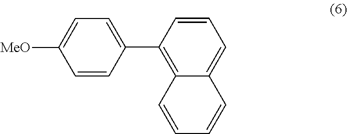 [SMILES: COc1ccc(-c2cccc3ccccc23)cc1]

To a mixture of 4-chloroanisole (62 μL, 0.50 mmol, 1 equiv), 1-napthylboronic acid (94 mg, 0.55 mmol, 1.1 equiv), and K₃PO₄·H₂O (0.35 g, 1.5 mmol, 3 equiv) was added toluene (800 L), a THF stock solution of 3 and PAd₃ (100 μL, 0.25 mol Pd/PAd₃) and the mixture was stirred at room temperature for 5 h. The reaction mixture was diluted with ethyl acetate then extracted with water. The combined organic layers were evaporated and the crude product was purified by flash chromatography. After drying, 104 mg of 6 (89%) was obtained as a white solid. NMR spectroscopic data agreed with literature values.

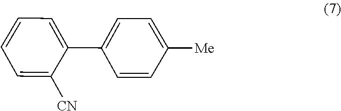

A mixture of 2-chlorobenzonitrile (69 mg, 0.50 mmol, 1 equiv), 4-tolylboronic acid (75 mg, 0.55 mmol, 1.1 equiv), THF (100 μL) were stirred into slurry, added K₃PO₄·5H₂O (0.33 g, 1.1 mmol, 2.2 equiv) then a THF stock solution of 3 and PAd₃ (10 μL, 0.025 mol Pd/PAd₃). The reaction vial was capped then taken outside the glove box to an oil bath preset at 100° C. for 10 min. The reaction mixture was diluted with ethyl acetate then extracted with water. The combine organic layers were evaporated and the crude product was purified by flash chromatography. After drying, 92 mg (95%) of 7 was obtained as a colorless crystalline solid. NMR spectroscopic data agreed with literature values.

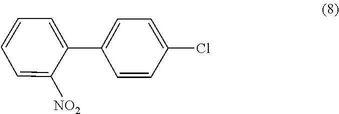 [SMILES: O=[N+]([O-])c1ccccc1-c1ccc(Cl)cc1]

A mixture of 1-chloro-2-nitrobenzene (79 mg, 0.50 mmol, 1 equiv), 4-chlorophenylboronic acid (80 mg, 0.51 mmol, 1.02 equiv), and THF (100 L) were stirred into slurry. Then K₃PO₄·5H₂O (0.33 g, 1.1 mmol, 2.2 equiv) was added followed by a THF stock solution of 3 and PAd₃ (10 μL in THF, 0.025 mol of Pd/PAd₃). The reaction vial was capped then taken outside the glove box to an oil bath preset at 100° C. for 10 min. The reaction mixture was diluted with ethyl acetate then extracted with water. The combined organic layers were evaporated and the crude product was purified by flash chromatography. After drying, 114 mg (97%) of 8 was obtained as a light yellow oil. NMR spectroscopic data agreed with literature values.

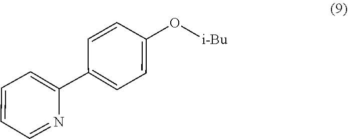

A mixture of 2-chloropyridine (47 μL, 0.50 mmol, 1 equiv), (4-isobutoxyphenyl)boronic acid (107 mg, 0.55 mmol, 1.1 equiv), and n-butanol (200 μL) were stirred into slurry. Then K₃PO₄·5H₂O (0.33 g, 1.1 mmol, 2.2 equiv) was added followed by a THF stock solution of 3 and PAd₃ (10 μL, 0.025 mol of Pd/PAd₃). The reaction vial was capped then taken outside the glove box to an oil bath preset at 100° C. for 1 h. The reaction mixture was diluted with ethyl acetate then extracted with water. The combined organic layers were evaporated and the crude product was purified by flash chromatography. After drying, 84 mg (74%) of 9 was obtained as a white solid.

¹H NMR (501 MHz, CDCl₃) δ 8.67 (ddd, J=4.9, 1.8, 1.0 Hz, 1H), 8.00-7.92 (m, 2H), 7.77-7.66 (m, 2H), 7.19 (ddd, J=7.2, 4.9, 1.4 Hz, 1H), 7.05-6.98 (m, 2H), 3.80 (d, J=6.5 Hz, 2H), 2.14 (dp, J=13.3, 6.7 Hz, 1H), 1.07 (d, J=6.7 Hz, 6H).

¹³C{¹H} NMR (126 MHz, CDCl₃) δ 160.2, 157.2, 149.5, 136.6, 131.8, 128.1, 121.3, 119.8, 114.7, 74.5, 28.3, 19.3.

HRMS (ESI) m/z calculated for C₁₅H₁₇NO (M+1) 228.1383, found 228.1392.

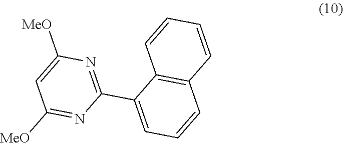 [SMILES: COc1cc(OC)nc(-c2cccc3ccccc23)n1]

A mixture of 2-chloro-4,6-dimethoxypyrimidine (87 mg, 0.50 mmol, 1 equiv), 2-napthylboronic acid (95 mg, 0.55 mmol, 1.1 equiv), THF (150 L) were stirred into slurry. Then K₃PO₄·5H₂O (0.33 g, 1.1 mmol, 2.2 equiv) was added followed by a THF stock solution of 3 and PAd₃ (10 μL, 0.025 mol of Pd/PAd₃). The reaction vial was capped then taken outside the glove box to an oil bath preset at 100° C. for 5 h. The reaction mixture was diluted with ethyl acetate then extracted with water. The combine organic layers were evaporated and the crude product was purified by flash chromatography. After drying, 106 mg (80%) of 10 was obtained as a white solid.

¹H NMR (501 MHz, CDCl₃) δ 8.99-8.92 (m, 1H), 8.22 (ddt, J=7.0, 2.7, 1.4 Hz, 1H), 7.97 (ddt, J=23.5, 8.1, 1.4 Hz, 2H), 7.64-7.51 (m, 3H), 6.14-6.09 (m, 1H), 4.11-4.06 (m, 6H).

¹³C{¹H}{¹H} NMR (126 MHz, CDCl₃) δ 171.3, 165.7, 135.5, 134.2, 131.1, 130.6, 129.4, 128.5, 126.5, 126.3, 125.7, 125.1, 88.0, 54.2.

HRMS (ESI) m/z calculated for C₁₆H₁₄N₂O₂ (M+1) 267.1128, found 267.1123.

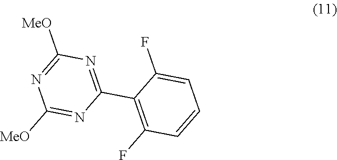 [SMILES: COc1nc(OC)nc(-c2c(F)cccc2F)n1]

To a mixture of 2-chloro-4,6-dimethoxy-1,3,5-triazine (88 mg, 0.50 mmol, 1 equiv), 2,6-difluorophenylboronic acid (118 mg, 0.75 mmol, 1.5 equiv), and K₂CO₃·1.5H₂O (0.25 g, 1.5 mmol, 3 equiv) was added THF (300 L) then a THF stock solution of 3 and PAd₃ (200 μL in THF, 0.5 mol) and the mixture was stirred at room temperature for 5 h. The reaction mixture was diluted with ethyl acetate then extracted with water. The combine organic layers were evaporated and the crude product was purified by flash chromatography. After drying, 118 mg (93%) of 11 was obtained as a white solid.

¹H NMR (501 MHz, CDCl₃) δ 7.39 (tt, J=8.4, 6.2 Hz, 1H), 7.02-6.93 (m, 2H), 4.07 (s, 6H).

¹³C{¹H}{¹H} NMR (126 MHz, CDCl₃) δ 172.5, 170.6 (t, J=1.6 Hz), 160.6 (dd, J=255.1, 6.0 Hz), 131.9 (t, J=11.3 Hz), 115.4 (t, J=16.4 Hz), 111.9 (dd, J=20.2, 5.0 Hz), 55.5.

HRMS (ESI) m/z calculated for C₁₁H₉F₂N₃O₂ (M+1) 254.0736, found 254.0722.

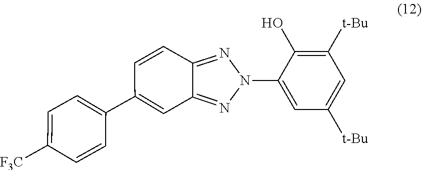 [SMILES: CC(C)(C)c1cc(-n2nc3ccc(-c4ccc(C(F)(F)F)cc4)cc3n2)c(O)c(C(C)(C)C)c1]

To a mixture of 2,4-di-tert-butyl-6-(5-chloro-2H-benzotriazol-2-yl)phenol (179 mg, 0.50 mmol, 1 equiv), 4-trifluoromethylphenylboronic acid (114 mg, 0.60 mmol, 1.2 equiv), K₃PO₄·5H₂O (0.36 g, 1.2 mmol, 2.4 equiv), and KOtBu (56 mg, 0.50 mmol, 1 equiv) was added a THF stock solution of 3 and PAd₃ (2 mL in THF, 5 mol of Pd/PAd₃). The mixture was stirred at 70° C. for 5 h. The reaction mixture was diluted with ethyl acetate then extracted with water. The combine organic layers were evaporated and the crude product was purified by flash chromatography. After drying, 224 mg (96%) of 12 was obtained as a white solid.

¹H NMR (500 MHz, CDCl₃) δ 11.63 (s, 1H), 8.22 (d, J=2.4 Hz, 1H), 8.01 (t, J=1.2 Hz, 1H), 7.91 (dd, J=8.9, 0.9 Hz, 1H), 7.71-7.58 (m, 5H), 7.37 (d, J=2.4 Hz, 1H), 1.44 (s, 9H), 1.32 (s, 9H).

¹³C{¹H}{¹H} NMR (126 MHz, CDCl₃) δ 145.7, 143.0, 142.0, 141.3, 140.7, 138.1, 137.6, 128.8 (q, J=32.6 Hz), 126.7, 126.7, 125.0 (q, J=3.7 Hz), 124.4, 124.1, 123.1 (q, J=272.2 Hz), 117.1, 115.1, 114.6, 34.7, 33.6, 30.5, 28.5.

HRMS (ESI) m/z calculated for C₂₇H₂₈F₃N₃O (M+1) 468.2257, found 468.2257.

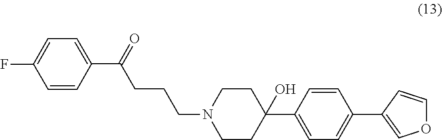 [SMILES: O=C(CCCN1CCC(O)(c2ccc(-c3ccoc3)cc2)CC1)c1ccc(F)cc1]

To a mixture of haloperidol (94 mg, 0.25 mmol, 1 equiv), furan-3-ylboronic acid (42 mg, 0.38 mmol, 1.5 equiv), 1,3,5-trimethyoxybenzene (42 mg, 0.25 mmol, 1 equiv) as internal standard, and K₃PO₄·H₂O (0.17 g, 0.75 mmol, 3 equiv) was added THF (400 μL) and a THF stock solution of 3 and PAd₃ (100 μL, 0.25 mol of Pd/PAd₃) and the mixture was stirred at 100° C. for 12 h. The NMR yield of 13 was 80% determined against the internal standard. The reaction mixture was diluted with ethyl acetate then extracted with water. The combine organic layers were evaporated and the crude product was purified by flash chromatography and preparative HPLC. After drying, 56 mg (55%) of 13 was obtained as a white solid.

¹H NMR (501 MHz, CDCl₃) δ 8.09-8.01 (m, 2H), 7.75 (t, J=1.2 Hz, 1H), 7.49 (d, J=3.5 Hz, 5H), 7.21-7.12 (m, 2H), 6.72 (dd, J=1.8, 0.9 Hz, 1H), 3.02 (t, J=7.1 Hz, 2H), 2.83 (d, J=11.2 Hz, 2H), 2.56-2.44 (m, 4H), 2.04 (td, J=16.6, 14.3, 9.7 Hz, 4H), 1.79-1.72 (m, 2H).

¹³C{¹H} NMR (126 MHz, CDCl₃) δ 198.4, 165.6 (d, J=254.3 Hz), 143.7, 138.5, 131.2, 130.7, 130.7, 126.0, 125.8, 125.0, 115.7, 115.5, 108.8, 71.3, 57.9, 49.4, 38.4, 36.3, 22.0.

HRMS (ESI) m/z calculated for C₂₅H₂₇FNO₃ (M+1) 408.1969, found 408.1960.

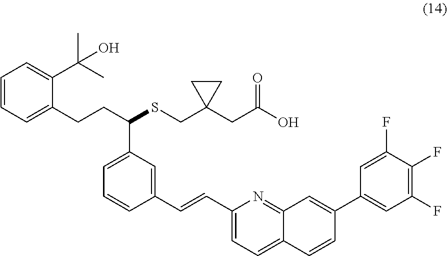 [SMILES: CC(C)(O)c1ccccc1CC[C@@H](SCC1(CC(=O)O)CC1)c1cccc(/C=C/c2ccc3ccc(-c4cc(F)c(F)c(F)c4)cc3n2)c1]

To a mixture of montelukast sodium salt (152 mg, 0.25 mmol, 1 equiv), 3,4,5-trifluorophenyl boronic acid (53 mg, 0.30 mmol, 1.2 equiv), and K₃PO₄·5H₂O (0.18 g, 0.60 mmol, 2.4 equiv) was added THF (2 mL) then a THF stock solution of 3 and PAd₃ (1 mL, 2.5 mol of Pd/PAd₃). The mixture was stirred at 100° C. for 5 h. The reaction mixture was diluted with ethyl acetate then extracted with saturated ammonium chloride then water. The combine organic layers were evaporated and the crude product was purified by flash chromatography. After drying, 152 mg (89%) of 14 was obtained as yellow solid.

¹H NMR (500 MHz, CDCl₃) δ 8.18 (d, J=1.8 Hz, 1H), 8.10 (d, J=8.5 Hz, 1H), 7.82 (d, J=8.4 Hz, 1H), 7.74 (d, J=1.9 Hz, 1H), 7.67 (d, J=8.6 Hz, 1H), 7.62 (dd, J=5.0, 1.8 Hz, 1H), 7.59 (d, J=17.1 Hz, 1H), 7.48 (d, J=17.1 Hz, 1H), 7.40 (m, 1H), 7.37-7.28 (m, 5H), 7.18-7.13 (m, 2H), 7.10 (ddd, J=7.6, 5.8, 3.0 Hz, 1H), 5.29 (s, 1H), 4.01 (t, J=7.2 Hz, 1H), 3.17 (ddd, J=13.5, 11.2, 5.1 Hz, 1H), 2.90 (ddd, J=13.5, 11.2, 5.4 Hz, 1H), 2.65 (d, J=13.1 Hz, 1H), 2.57 (d, J=16.2 Hz, 1H), 2.45 (d, J=13.1 Hz, 1H), 2.38 (d, J=16.1 Hz, 1H), 2.28-2.09 (m, 2H), 1.60 (d, J=4.9 Hz, 6H), 0.71-0.24 (m, 4H).

¹³C{¹H} NMR (126 MHz, CDCl₃) δ 176.3, 156.9, 151.5 (ddd, J=249.9, 10.0, 4.2 Hz), 147.7, 145.2, 143.6, 140.2, 139.7 (dt, J=253.3, 15.4 Hz), 139.4, 136.5, 136.4, 136.3 (m), 135.4, 131.5, 129.0, 128.6, 128.5, 128.4, 127.1, 126.9, 126.5, 126.5, 126.4, 125.6, 125.4, 125.0, 119.4, 111.4 (dd, J=12.6, 5.0 Hz), 73.8, 50.3, 40.3, 40.0, 38.9, 32.3, 31.8, 16.8, 12.7, 12.4.

HRMS (ESI) m/z calculated for C₄₁H₃₈F₃NO₃S (M+1) 682.2597, found 682.2598.

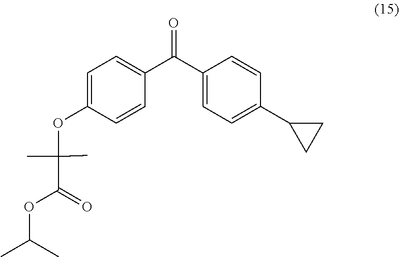 [SMILES: CC(C)OC(=O)C(C)(C)Oc1ccc(C(=O)c2ccc(C3CC3)cc2)cc1]

To a mixture of fenofibrate (90 mg, 0.25 mmol, 1 equiv), cyclopropylboronic acid (32 mg, 0.38 mmol, 1.5 equiv), and K₃PO₄·H₂O (0.18 g, 0.75 mmol, 3 equiv) was added toluene (400 μL) then a THF stock solution of 3 and PAd₃ (50 μL, 0.125 mol of Pd/PAd₃). The mixture was stirred at 100° C. for 5 h. The reaction mixture was diluted with ethyl acetate then extracted with water. The combine organic layers were evaporated and the crude product was purified by flash chromatography. After drying, 84 mg (92%) of 15 was obtained as a white solid.

¹H NMR (501 MHz, CDCl₃) δ 7.80-7.72 (m, 2H), 7.72-7.66 (m, 2H), 7.19-7.12 (m, 2H), 6.91-6.84 (m, 2H), 5.11 (hept, J=6.3 Hz, 1H), 1.99 (tt, J=8.4, 5.0 Hz, 1H), 1.68 (s, 6H), 1.23 (d, J=6.3 Hz, 6H), 1.13-1.05 (m, 2H), 0.85-0.78 (m, 2H).

¹³C{¹H} NMR (126 MHz, CDCl₃) δ 195.2, 173.2, 159.3, 149.2, 135.2, 131.9, 131.0, 130.1, 125.2, 117.1, 79.3, 69.3, 25.4, 21.5, 15.7, 10.3.

HRMS (ESI) m/z calculated for C₂₃H₂₆O₄ (M+1) 367.1904, found 367.1888.

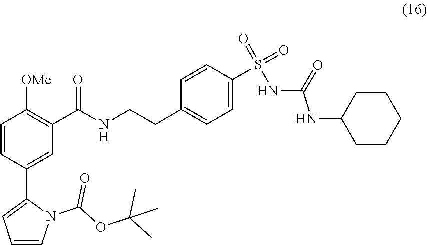 [SMILES: COc1ccc(-c2cccn2C(=O)OC(C)(C)C)cc1C(=O)NCCc1ccc(S(=O)(=O)NC(=O)NC2CCCCC2)cc1]

To a mixture of glibenclamide (247 mg, 0.50 mmol, 1 equiv), N-Boc-pyrroleboronic acid (127 mg, 0.60 mmol, 1.2 equiv), 1,3,5-trimethyoxybenzene (84 mg, 0.50 mmol, 1 equiv) as internal standard, and K₃PO₄·5H₂O (0.36 g, 1.2 mmol, 2.4 equiv) was added a THF stock solution of 3 and PAd₃ (2 mL in THF, 5 mol of Pd/PAd₃). The mixture was stirred at 100° C. for 5 h. The crude NMR yield was 65% versus the internal standard. The reaction mixture was diluted with ethyl acetate then extracted with water. The combine organic layers were evaporated and the crude product was purified by flash chromatography and preparative HPLC. After drying, 116 mg (37%) of 16 was obtained as a white solid.

¹H NMR (501 MHz, CDCl₃) δ 8.13 (d, J=2.4 Hz, 1H), 7.83 (t, J=5.8 Hz, 1H), 7.78 (d, J=8.3 Hz, 2H), 7.43-7.31 (m, 3H), 7.26 (dd, J=3.3, 1.8 Hz, 1H), 6.86 (d, J=8.5 Hz, 1H), 6.37 (d, J=7.9 Hz, 1H), 6.14 (t, J=3.3 Hz, 1H), 6.11 (dd, J=3.3, 1.8 Hz, 1H), 3.75 (s, 3H), 3.69 (q, J=6.6 Hz, 2H), 3.56-3.47 (m, 1H), 2.96 (t, J=6.9 Hz, 2H), 1.80-1.72 (m, 2H), 1.64-1.46 (m, 4H), 1.34 (s, 9H), 1.30-1.03 (m, 4H).

¹³C{¹H} NMR (126 MHz, CDCl₃) δ 165.2, 156.6, 150.1, 149.2, 146.3, 137.7, 133.8, 133.6, 133.0, 129.9, 127.7, 127.2, 122.6, 120.3, 114.7, 110.6, 110.6, 83.7, 56.0, 49.2, 40.5, 35.7, 33.0, 27.8, 25.4, 24.6.

HRMS (ESI) m/z calculated for C₃₂H₄₀N₄O₇S (M+1) 625.2691, found 625.2700.

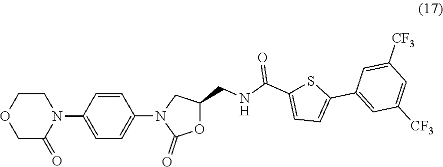 [SMILES: O=C(NC[C@@H]1CN(c2ccc(N3CCOCC3=O)cc2)C(=O)O1)c1ccc(-c2cc(C(F)(F)F)cc(C(F)(F)F)c2)s1]

To a mixture of 5-R-rivaroxaban (55 mg, 0.13 mmol, 1 equiv), 3,5-bis(trifluoromethyl) phenylboronic acid (35 mg, 0.14 mmol, 1.1 equiv), 1,3,5-trimethyoxybenzene (21 mg, 0.13 mmol, 1 equiv) as internal standard, and K₃PO₄·5H₂O (82 mg, 0.28 mmol, 2.2 equiv) was added a THF stock solution of 3 and PAd₃ (2.5 mL, 6.25 mol of Pd/PAd₃). The mixture was stirred at 100° C. for 5 h. The crude NMR yield was 83% versus the internal standard. The reaction mixture was diluted with ethyl acetate then extracted with water. The combine organic layers were evaporated and the crude product was purified by flash chromatography and preparative HPLC. After drying, 43 mg (56%) of 17 was obtained as a white solid.

¹H NMR (501 MHz, CDCl₃) δ 7.94 (s, 2H), 7.76 (s, 1H), 7.55-7.45 (m, 3H), 7.33 (d, J=3.9 Hz, 1H), 7.30-7.23 (m, 2H), 6.90 (s, 1H), 4.82 (dd, J=6.0, 3.0 Hz, 1H), 4.26 (s, 2H), 4.04 (t, J=8.9 Hz, 1H), 3.99-3.93 (m, 2H), 3.88-3.77 (m, 2H), 3.76-3.63 (m, 3H).

¹³C{¹H} NMR (126 MHz, CDCl₃) δ 166.9, 162.1, 154.4, 145.6, 139.0, 137.4, 136.6, 135.5, 132.3 (q, J=34.0 Hz), 127.6 (q, J=476.3 Hz), 126.3, 126.0, 124.1, 121.9, 119.2, 71.9, 68.6, 64.1, 49.7, 47.7, 42.4.

HRMS (ESI) m/z calculated for C₂₇H₂₁F₆N₃O₅S (M+1) 614.1179, found 614.1196.

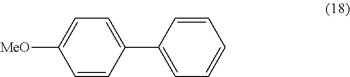 [SMILES: COc1ccc(-c2ccccc2)cc1]

To a mixture of 4-chloroanisole (62 μL, 0.50 mmol, 1 equiv), phenylboronic acid (67 mg, 0.55 mmol, 1.1 equiv), and K₃PO₄·H₂O (0.35 g, 1.5 mmol, 3 equiv) was added toluene (800 μL) then a THF stock solution of 3 and PAd₃ (100 μL, 0.25 μmol of Pd/PAd₃). The mixture was stirred at room temperature for 5 h. The reaction mixture was diluted with ethyl acetate then extracted with water. The combine organic layers were evaporated and the crude product was purified by flash chromatography. After drying, 75 mg (81%) of 18 was obtained as a white solid. NMR spectroscopic data agreed with literature values.

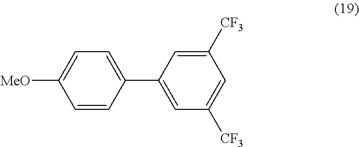 [SMILES: COc1ccc(-c2cc(C(F)(F)F)cc(C(F)(F)F)c2)cc1]

To a mixture of 4-chloroanisole (62 L, 0.50 mmol, 1 equiv), 3,5-bis(trifluoromethyl) phenylboronic acid (142 mg, 0.55 mmol, 1.1 equiv), and K₃PO₄·5H₂O (0.33 g, 1.1 mmol, 2.2 equiv) was added THF (400 μL) then a THF stock solution of 3 and PAd₃ (100 μL, 0.25 mol of Pd/PAd₃). The mixture was stirred at room temperature for 5 h. The reaction mixture was diluted with ethyl acetate then extracted with water. The combine organic layers were evaporated and the crude product was purified by flash chromatography. After drying, 146 mg (91%) of 19 was obtained as a colorless oil. NMR spectroscopic data agreed with literature values.

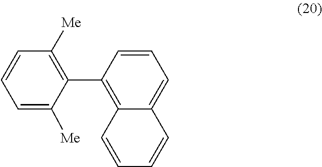 [SMILES: Cc1cccc(C)c1-c1cccc2ccccc12]

To a mixture of 2-chloro-1,3-dimethylbenzene (66 μL, 0.50 mmol, 1 equiv), 1-napthylboronic acid (129 mg, 0.75 mmol, 1.5 equiv), and K₃PO₄·5H₂O (0.45 g, 1.5 mmol, 3 equiv) was added THF (400 μL) then a THF stock solution of 3 and PAd₃ (100 μL, 0.25 mol of Pd/PAd₃). The mixture was stirred at 100° C. for 5 h. The reaction mixture was diluted with ethyl acetate then extracted with water. The combine organic layers were evaporated and the crude product was purified by flash chromatography. After drying, 93 mg (80%) of 20 was obtained as a white solid. NMR spectroscopic data agreed with literature values.

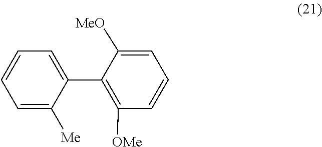 [SMILES: COc1cccc(OC)c1-c1ccccc1C]

To a mixture of 2-chlorotoluene (59 μL, 0.50 mmol, 1 equiv), 2,6-dimethoxyphenylboronic acid (136 mg, 0.75 mmol, 1.5 equiv), and K₃PO₄·H₂O (0.35 g, 1.5 mmol, 3 equiv) was added toluene (400 μL) then a catalyst stock solution of 3 and PAd₃ (100 L, 0.25 μmol of Pd/PAd₃). The mixture was stirred at 50° C. for 5 h. The reaction mixture was diluted with ethyl acetate then extracted with water. The combine organic layers were evaporated and the crude product was purified by flash chromatography. After drying, 79 mg (70%) of 21 was obtained as a white solid. NMR spectroscopic data agreed with literature values.

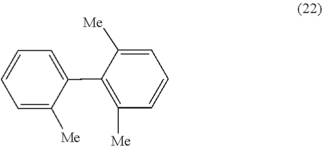 [SMILES: Cc1ccccc1-c1c(C)cccc1C]

To a mixture of 2-chlorotoluene (59 μL, 0.50 mmol, 1 equiv), 2,6-dimethylphenylboronic acid (112 mg, 0.75 mmol, 1.5 equiv), and K₃PO₄·5H₂O (0.45 g, 1.5 mmol, 3 equiv) was added THF (400 L) then a THF stock solution of 3 and PAd₃ (100 μL, 0.25 mol of Pd/PAd₃). The mixture was stirred at 100° C. for 9 h. The reaction mixture was diluted with ethyl acetate then extracted with water. The combine organic layers were evaporated and the crude product was purified by flash chromatography. After drying, 69 mg (70%) of 22 was obtained as a colorless oil. NMR spectroscopic data agreed with literature values.

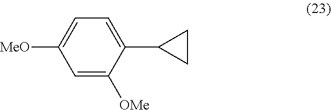 [SMILES: COc1ccc(C2CC2)c(OC)c1]

To a mixture of 1-bromo-2,4-dimethoxybenzene (72 μL, 0.50 mmol, 1 equiv), cyclopropylboronic acid (64 mg, 0.75 mmol, 1.5 equiv), and K₃PO₄·H₂O (0.35 mg, 1.5 mmol, 3 equiv) was added toluene (400 μL) then a THF stock solution of 3 and PAd₃ (100 μL, 0.25 mol of Pd/PAd₃) and the mixture was stirred at 100° C. for 5 h. The reaction mixture was diluted with ethyl acetate then extracted with water. The combine organic layers were evaporated and the crude product was purified by flash chromatography. After drying, 80 mg (90%) of 23 was obtained as a colorless oil. NMR spectroscopic data agreed with literature values.

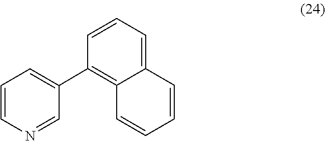 [SMILES: c1cncc(-c2cccc3ccccc23)c1]

To a mixture of 3-chloropyridine (48 μL, 0.50 mmol, 1 equiv), 1-napthylboronic acid (95 mg, 0.55 mmol, 1.1 equiv), and K₃PO₄·H₂O (0.35 g, 1.5 mmol, 3 equiv) was added toluene (400 μL) then a THF stock solution of 3 and PAd₃ (100 μL, 0.25 mol). The mixture was stirred at 90° C. for 5 h. The reaction mixture was diluted with ethyl acetate then extracted with water. The combine organic layers were evaporated and the crude product was purified by flash chromatography. After drying, 70 mg (68%) of 24 was obtained as a white solid. NMR spectroscopic data agreed with literature values.

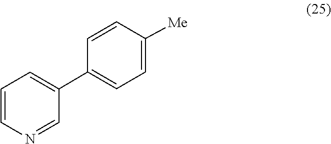 [SMILES: Cc1ccc(-c2cccnc2)cc1]

To a mixture of 3-chloropyridine (48 μL, 0.50 mmol, 1 equiv), 4-tolylboronic acid (75 mg, 0.55 mmol, 1.1 equiv), and K₃PO₄·H₂O (0.35 g, 1.5 mmol, 3 equiv) was added toluene (400 L) then a THF stock solution of 3 and PAd₃ (100 μL, 0.25 mol of Pd/PAd₃). The mixture was stirred at 90° C. for 5 h. The reaction mixture was diluted with ethyl acetate then extracted with water. The combine organic layers were evaporated and the crude product was purified by flash chromatography. After drying, 53 mg (63%) of 25 was obtained as a white solid. NMR spectroscopic data agreed with literature values.

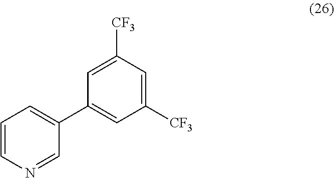 [SMILES: FC(F)(F)c1cc(-c2cccnc2)cc(C(F)(F)F)c1]

To a mixture of 3-chloropyridine (48 μL, 0.50 mmol, 1 equiv), 3,5-bis(trifluoromethyl) phenylboronic acid (142 mg, 0.55 mmol, 1.1 equiv), and K₃PO₄·H₂O (0.35 mg, 1.5 mmol, 3 equiv) was added toluene (400 μL) then a THF stock solution of 3 and PAd₃ (100 L, 0.25 mol of Pd/PAd₃). The mixture was stirred at 90° C. for 5 h. The reaction mixture was diluted with ethyl acetate then extracted with water. The combine organic layers were evaporated and the crude product was purified by flash chromatography. After drying, 143 mg (98%) of 26 was obtained as a white solid. NMR spectroscopic data agreed with literature values.

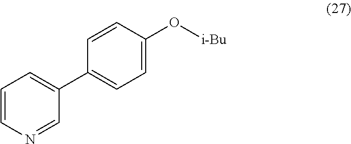

To a mixture of 3-chloropyridine (48 μL, 0.50 mmol, 1 equiv), (4-isobutoxyphenyl)boronic acid (107 mg, 0.55 mmol, 1.1 equiv), and K₃PO₄·5H₂O (0.33 g, 1.1 mmol, 2.2 equiv) was added THF (400 L) then a THF stock solution of 3 and PAd₃ (100 μL, 0.25 mol of Pd/PAd₃). The mixture was stirred at 100° C. for 12 h. The reaction mixture was diluted with ethyl acetate then extracted with water. The combine organic layers were evaporated and the crude product was purified by flash chromatography. After drying, 96 mg (84%) of 27 was obtained as a colorless oil.

¹H NMR (501 MHz, CDCl₃) δ 8.85-8.80 (m, 1H), 8.57-8.51 (m, 1H), 7.80 (dt, J=8.2, 1.9 Hz, 1H), 7.53-7.46 (m, 2H), 7.31 (dd, J=7.9, 5 Hz, 1H), 7.04-6.97 (m, 2H), 3.76 (d, J=6.6 Hz, 2H), 2.11 (dq, J=13.3, 6.7 Hz, 1H), 1.05 (d, J=6.9 Hz, 6H).

¹³C{¹H} NMR (126 MHz, CDCl₃) δ 159.5, 148.0, 147.8, 136.3, 133.8, 129.9, 128.1, 123.5, 115.1, 74.5, 28.3, 19.3.

HRMS (ESI) m/z calculated for C₁₅H₁₇NO (M+1) 228.1383, found 228.1377.

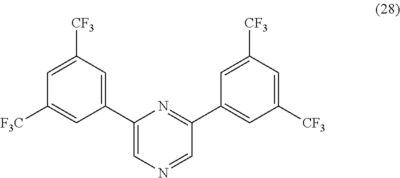 [SMILES: FC(F)(F)c1cc(-c2cncc(-c3cc(C(F)(F)F)cc(C(F)(F)F)c3)n2)cc(C(F)(F)F)c1]

To a mixture of 2,6-dichloropyrazine (37 mg, 0.25 mmol, 1 equiv), 3,5-bis(trifluoromethyl)phenylboronic acid (142 mg, 0.55 mmol, 2.2 equiv), and K₃PO₄·5H₂O (0.33 g, 1.1 mmol, 4.4 equiv) was added THF (400 L) then a THF stock solution of 3 and PAd₃ (100 L, 0.25 mol of Pd/PAd₃). The mixture was stirred at 70° C. for 5 h. The reaction mixture was diluted with ethyl acetate then extracted with water. The combine organic layers were evaporated and the crude product was purified by flash chromatography. After drying, 110 mg (87%) of 28 was obtained as a white solid.

¹H NMR (501 MHz, CDCl₃) δ 9.20 (s, 2H), 8.62-8.58 (m, 4H), 8.07 (s, 2H). ¹³C{¹H} NMR (126 MHz, CDCl₃) δ 149.2, 141.5, 137.9, 132.8 (q, J=33.7 Hz), 127.1, 123.9, 123.1 (q, J=273.4 Hz).

HRMS (ESI) m/z calculated for C₂₀H₈F₁₂N₂ (M+1) 505.0569, found 505.0563.

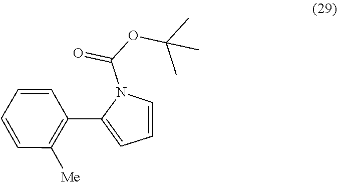 [SMILES: Cc1ccccc1-c1cccn1C(=O)OC(C)(C)C]

To a mixture of 2-chlorotoluene (59 μL, 0.50 mmol, 1 equiv), N-Boc-2-pyrroleboronic acid (158 mg, 0.75 mmol, 1.5 equiv), and K₃PO₄·5H₂O (0.45 g, 1.5 mmol, 3 equiv) was added THF (400 μL) then a THF stock solution of 3 and PAd₃ (100 μL, 0.25 mol of Pd/PAd₃). The mixture was stirred at room temperature for 5 h. The reaction mixture was diluted with ethyl acetate then extracted with water. The combine organic layers were evaporated and the crude product was purified by flash chromatography. After drying, 124 mg (96%) of 29 was obtained as a colorless oil. NMR spectroscopic data agreed with literature values.

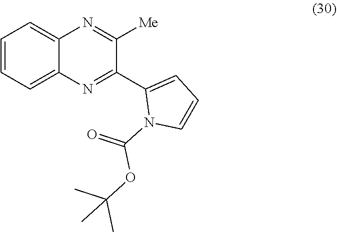 [SMILES: Cc1nc2ccccc2nc1-c1cccn1C(=O)OC(C)(C)C]

To a mixture of 2-chloro-3-methylquinoxaline (89 mg, 0.50 mmol, 1 equiv), N-Boc-2-pyrroleboronic acid (158 mg, 0.75 mmol, 1.5 equiv), and K₃PO₄μ5H₂O (0.45 g, 1.5 mmol, 3 equiv) was added THF (400 μL) then a THF stock solution of 3 and PAd₃ (100 μL, 0.25 mol of Pd/PAd₃). The mixture was stirred at 70° C. for 5 h. The reaction mixture was diluted with ethyl acetate then extracted with water. The combine organic layers were evaporated and the crude product was purified by flash chromatography. After drying, 148 mg (96%) of 30 was obtained as a white solid.

¹H NMR (501 MHz, CDCl₃) δ 8.09-7.98 (m, 2H), 7.74-7.63 (m, 2H), 7.43 (dd, J=3.4, 1.7 Hz, 1H), 6.44 (dd, J=3.3, 1.7 Hz, 1H), 6.33 (t, J=3.4 Hz, 1H), 2.56 (s, 3H), 1.17 (s, 9H).

¹³C{¹H} NMR (126 MHz, CDCl₃) δ 154.5, 149.6, 148.6, 141.2, 140.3, 130.7, 129.8, 129.1, 129.0, 128.3, 122.5, 115.6, 111.4, 84.2, 27.4, 23.0.

HRMS (ESI) m/z calculated for C₁₈H₁₉N₃O₂ (M+1) 310.1550, found 310.1552.

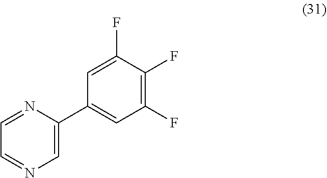 [SMILES: Fc1cc(-c2cnccn2)cc(F)c1F]

To a mixture of 2-chloropyrazine (44 μL, 0.50 mmol, 1 equiv), 3,4,5-trifluorophenyl-boronic acid (132 mg, 0.75 mmol, 1.5 equiv), and K₃PO₄·5H₂O (0.45 g, 1.5 mmol, 3 equiv) was added THF (400 μL) then a THF stock solution of 3 and PAd₃ (100 μL, 0.25 mol of Pd/PAd₃). The mixture was stirred at 70° C. for 5 h. The reaction mixture was diluted with ethyl acetate then extracted with water. The combine organic layers were evaporated and the crude product was purified by flash chromatography. After drying, 77 mg (73%) of 31 was obtained as a white solid.

¹H NMR (501 MHz, CDCl₃) δ 8.98 (d, J=1.6 Hz, 1H), 8.66-8.62 (m, 1H), 8.57 (d, J=2.5 Hz, 1H), 7.75-7.65 (m, 2H).

¹³C{¹H} NMR (126 MHz, CDCl₃) δ 151.7 (ddd, J=250.7, 10.2, 4.0 Hz), 149.4 (dt, J=1.3, 2.5 Hz), 144.3, 144.0, 141.6, 140.9 (dt, J=255.8, 15.4 Hz), 132.3 (dt, J=5.0, 7.6 Hz), 111.0 (dd, J=17.1, 5.5 Hz).

HRMS (ESI) m/z calculated for C₁₀H₅F₃N₂ (M+1) 211.0478, found 211.0471.

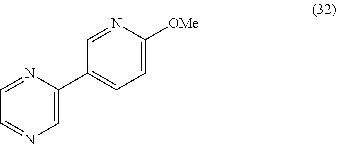 [SMILES: COc1ccc(-c2cnccn2)cn1]

To a mixture of 2-chloropyrazine (44 μL, 0.50 mmol, 1 equiv), (6-methoxypyridin-3-yl)boronic acid (115 mg, 0.75 mmol, 1.5 equiv), and K₃PO₄·5H₂O (0.45 g, 1.5 mmol, 3.0 equiv) was added THF (400 μL) then a THF stock solution of 3 and PAd₃ (100 μL, 0.25 mol of Pd/PAd₃). The mixture was stirred at 70° C. for 5 h. The reaction mixture was diluted with ethyl acetate then extracted with water. The combine organic layers were evaporated and the crude product was purified by flash chromatography. After drying, 77 mg (82%) of 32 was obtained as a white solid.

¹H NMR (501 MHz, CDCl₃) δ 8.89 (d, J=1.6 Hz, 1H), 8.72 (d, J=2.6 Hz, 1H), 8.54-8.49 (m, 1H), 8.41 (d, J=2.6 Hz, 1H), 8.15 (dd, J=8.7, 2.5 Hz, 1H), 6.79 (d, J=8.7 Hz, 1H), 3.92 (s, 3H).

¹³C{¹H} NMR (126 MHz, CDCl₃) δ 165.2, 150.6, 145.7, 144.2, 142.8, 141.3, 137.1, 125.6, 111.4, 53.8.

HRMS (ESI) m/z calculated for C₁₀H₉N₃O (M+1) 118.0818, found 118.0814.

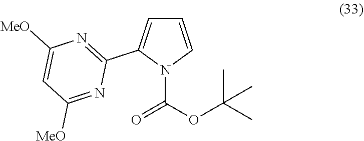 [SMILES: COc1cc(OC)nc(-c2cccn2C(=O)OC(C)(C)C)n1]

To a mixture of 2-chloro-4,6-dimethoxypyrimidine (87 mg, 0.50 mmol, 1 equiv), N-Boc-2-pyrroleboronic acid (116 mg, 0.55 mmol, 1.1 equiv), and K₃PO₄·5H₂O (0.33 g, 1.1 mmol, 2.2 equiv) was added n-butanol (400 L) then a THF stock solution of 3 and PAd₃ (100 μL, 0.25 mol of Pd/PAd₃). The mixture was stirred at room temperature for 5 h. The reaction mixture was diluted with ethyl acetate then extracted with water. The combine organic layers were evaporated and the crude product was purified by flash chromatography. After drying, 147 mg (96%) of 33 was obtained as a colorless oil.

¹H NMR (501 MHz, CDCl₃) δ 7.33 (dd, J=3.1, 1.7 Hz, 1H), 6.77 (dd, J=3.4, 1.7 Hz, 1H), 6.26 (t, J=3.3 Hz, 1H), 5.95 (s, 1H), 3.97 (s, 6H), 1.48 (s, 9H).

¹³C{¹H} NMR (126 MHz, CDCl₃) δ 171.0, 159.4, 149.0, 133.0, 124.8, 117.9, 110.5, 87.6, 83.6, 54.0, 27.7.

HRMS (ESI) m/z calculated for C₁₅H₁₉N₃O₄ (M+1) 306.1448, found 306.1431.

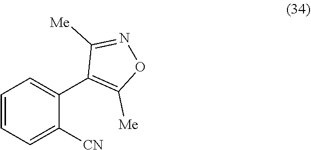 [SMILES: Cc1noc(C)c1-c1ccccc1C#N]

To a mixture of 2-chlorobenzonitrile (69 mg, 0.50 mmol, 1 equiv), (3,5-dimethylisoxazol-4-yl)boronic acid (106 mg, 0.75 mmol, 1.5 equiv), and K₃PO₄·5H₂O (0.45 g, 1.5 mmol, 3 equiv) was added THF (400 L) then a THF stock solution of 3 and PAd₃ (100 μL, 0.25 mol of Pd/PAd₃). The mixture was stirred at 100° C. for 9 h. The reaction mixture was diluted with ethyl acetate then extracted with water. The combine organic layers were evaporated and the crude product was purified by flash chromatography. After drying, 78 mg (79%) of 34 was obtained as a colorless oil. NMR spectroscopic data agreed with literature values.

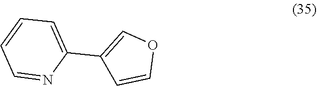 [SMILES: c1ccc(-c2ccoc2)nc1]

To a mixture of 2-chloropyridine (47 μL, 0.50 mmol, 1 equiv), furan-3-ylboronic acid (84 mg, 0.75 mmol, 1.5 equiv), and K₃PO₄·H₂O (0.35 g, 1.5 mmol, 3 equiv) was added THF (400 μL) then a THF stock solution of 3 and PAd₃ (100 μL, 0.25 mol of Pd/PAd₃). The mixture was stirred at 100° C. for 12 h. The reaction mixture was diluted with ethyl acetate then extracted with water. The combine organic layers were evaporated and the crude product was purified by flash chromatography. After drying, 80 mg (92%) of 35 was obtained as a colorless oil. NMR spectroscopic data agreed with literature values.

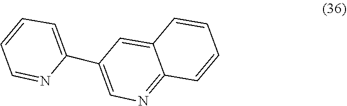 [SMILES: c1ccc(-c2cnc3ccccc3c2)nc1]

To a mixture of 2-chloropyridine (47 μL, 0.50 mmol, 1 equiv), quinolin-3-ylboronic acid (130 mg, 0.75 mmol, 1.5 equiv), and K₃PO₄·H₂O (0.35 g, 1.5 mmol, 3 equiv) was added n-butanol (400 L) then a THF stock solution of 3 and PAd₃ (100 μL, 0.25 mol of Pd/PAd₃). The mixture was stirred at 100° C. for 5 h. The reaction mixture was diluted with ethyl acetate then extracted with water. The combine organic layers were evaporated and the crude product was purified by flash chromatography. After drying, 83 mg (80%) of 36 was obtained as a white solid. NMR spectroscopic data agreed with literature values.

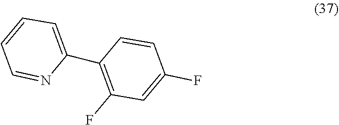 [SMILES: Fc1ccc(-c2ccccn2)c(F)c1]

To a mixture of 2-chloropyridine (47 L, 0.50 mmol, 1 equiv), 2,4-difluorophenylboronic acid (118 mg, 0.75 mmol, 1.5 equiv), and K₃PO₄·5H₂O (0.45 mg, 1.5 mmol, 3 equiv) was added THF (400 μL) then a THF stock solution of 3 and PAd₃ (100 μL, 0.25 mol of Pd/PAd₃). The mixture was stirred at 70° C. for 4 h. The reaction mixture was diluted with ethyl acetate then extracted with water. The combine organic layers were evaporated and the crude product was purified by flash chromatography. After drying, 89 mg (93%) of 37 was obtained as a colorless oil. NMR spectroscopic data agreed with literature values.

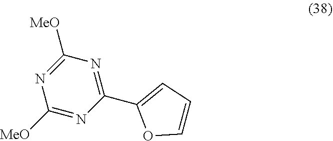 [SMILES: COc1nc(OC)nc(-c2ccco2)n1]

To a mixture of 2-chloro-4,6-dimethoxy-1,3,5-triazine (88 mg, 0.50 mmol, 1 equiv), furan-2-ylboronic acid (84 mg, 0.75 mmol, 1.5 equiv), and K₃PO₄·5H₂O (0.45 mg, 1.5 mmol, 3 equiv) was added THF (400 μL) then a THF stock solution of 3 and PAd₃ (100 μL, 0.25 mol of Pd/PAd₃). The mixture was stirred at room temperature for 1.5 h. The reaction mixture was diluted with ethyl acetate then extracted with water. The combine organic layers were evaporated and the crude product was purified by flash chromatography. After drying, 93 mg (90%) of 38 was obtained as a white solid.

¹H NMR (501 MHz, CDCl₃) δ 7.64-7.59 (m, 1H), 7.44 (d, J=3.5 Hz, 1H), 6.53 (dd, J=3.4, 1.7 Hz, 1H), 4.03 (s, 6H).

¹³C{¹H} NMR (126 MHz, CDCl₃) δ 172.6, 166.5, 150.1, 146.6, 117.4, 112.5, 55.2.

HRMS (ESI) m/z calculated for C₉H₉N₃O₃ (M+1) 208.0717, found 208.0706.

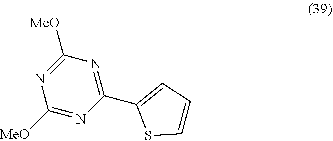 [SMILES: COc1nc(OC)nc(-c2cccs2)n1]

To a mixture of 2-chloro-4,6-dimethoxy-1,3,5-triazine (88 mg, 0.50 mmol, 1 equiv), thiophen-2-ylboronic acid (96 mg, 0.75 mmol, 1.5 equiv), and K₃PO₄·5H₂O (0.45 mg, 1.5 mmol, 3 equiv) was added THF (400 L) then a THF stock solution of 3 and PAd₃ (100 μL, 0.25 mol of Pd/PAd₃). The mixture was stirred at room temperature for 5 h. The reaction mixture was diluted with ethyl acetate then extracted with water. The combine organic layers were evaporated and the crude product was purified by flash chromatography. After drying, 104 mg (93%) of 39 was obtained as a white solid. NMR spectroscopic data agreed with literature values.

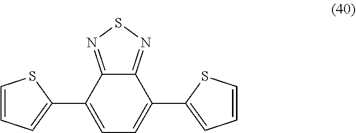 [SMILES: c1csc(-c2ccc(-c3cccs3)c3nsnc23)c1]

To a mixture of 4,7-dibromobenzo[c][1,2,5]thiadiazole (147 mg, 0.50 mmol, 1 equiv), thiophen-2-ylboronic acid (192 mg, 1.50 mmol, 3 equiv), and K₃PO₄·5H₂O (0.90 g, 3.0 mmol, 6 equiv) was added THF (900 μL) then a THF stock solution of 3 and PAd₃ (100 μL, 0.25 mol of Pd/PAd₃). The mixture was stirred at room temperature for 1 h. The reaction mixture was diluted with ethyl acetate then extracted with water. The combine organic layers were evaporated and the crude product was purified by flash chromatography. After drying, 143 mg (95%) of 40 was obtained as an orange solid. NMR spectroscopic data agreed with literature values.

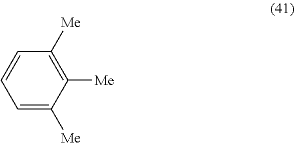

To a mixture of 2-chloro-1,3-dimethylbenzene (66 μL, 0.50 mmol, 1 equiv), methylboronic acid (45 mg, 0.75 mmol, 1.5 equiv), 1,3,5-trimethyoxybenzene (84 mg, 0.50 mmol, 1 equiv) as internal standard, and K₃PO₄·5H₂O (0.45 g, 1.5 mmol, 3 equiv) was added THF (400 μL) then a THF stock solution of 3 and PAd₃ (100 μL, 0.25 mol of Pd/PAd₃). The mixture was stirred at 50° C. for 5 h. The crude NMR yield was 90% versus the internal standard. The reaction mixture was diluted with ethyl acetate then extracted with water. The combine organic layers were evaporated and the crude product was purified by flash chromatography. After drying, 30 mg (50%) of 41 was obtained as a colorless oil.

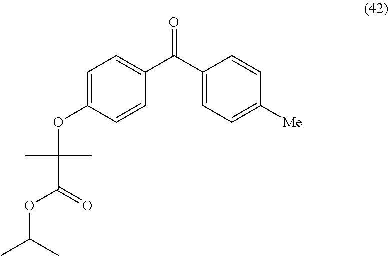 [SMILES: Cc1ccc(C(=O)c2ccc(OC(C)(C)C(=O)OC(C)C)cc2)cc1]

To a mixture of fenofibrate (90 mg, 0.25 mmol, 1 equiv), methylboronic acid (30 mg, 0.50 mmol, 2 equiv), 1,3,5-trimethyoxybenzene (42 mg, 0.25 mmol, 1 equiv) as internal standard, and K₃PO₄·H₂O (0.18 g, 0.75 mmol, 3 equiv) was added toluene (400 μL) then a THF stock solution of 3 and PAd₃ (50 μL, 0.125 mol of Pd/PAd₃). The mixture was stirred at 100° C. for 5 h. The crude NMR yield was 88% versus internal standard. The reaction mixture was diluted with ethyl acetate then extracted with water. The combine organic layers were evaporated and the crude product was purified by flash chromatography and preparative HPLC. After drying, 65 mg (76%) of 42 was obtained as a white solid.

¹H NMR (501 MHz, CDCl₃) δ 7.80-7.73 (m, 2H), 7.71-7.65 (m, 2H), 7.28 (d, J=7.9 Hz, 2H), 6.92-6.84 (m, 2H), 5.10 (hept, J=6.3 Hz, 1H), 2.44 (s, 3H), 1.67 (s, 6H), 1.22 (d, J=6.3 Hz, 6H).

¹³C{¹H} NMR (126 MHz, CDCl₃) δ 195.3, 173.2, 159.3, 142.7, 135.4, 131.9, 130.9, 130.0, 128.9, 117.1, 79.3, 69.3, 25.4, 21.6, 21.5.

HRMS (ESI) m/z calculated for C₂₁H₂₄O₄ (M+1) 341.1747, found 341.1749.

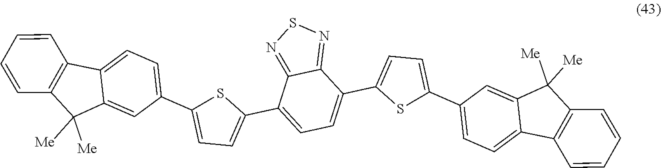 [SMILES: CC1(C)c2ccccc2-c2ccc(-c3ccc(-c4ccc(-c5ccc(-c6ccc7c(c6)C(C)(C)c6ccccc6-7)s5)c5nsnc45)s3)cc21]

To a mixture of 4,7-bis(5-bromothiophen-2-yl)benzo[c][1,2,5]thiadiazole (115 mg, 0.25 mmol, 1 equiv),²⁹ (9,9-dimethyl-9H-fluoren-2-yl)boronic acid (131 mg, 0.55 mmol, 2.2 equiv), and K₃PO₄·5H₂O (0.33 g, 1.1 mmol, 4.4 equiv) was added THF (900 μL) then a THF stock solution of 3 and PAd₃ (100 μL, 0.25 mol of Pd/PAd₃). The mixture was stirred at room temperature for 1 h. The reaction mixture was diluted with ethyl acetate then extracted with water. The combine organic layers were evaporated and the crude product was purified by flash chromatography. After drying, 152 mg (89%) of 43 was obtained as a dark red solid.

¹H NMR (501 MHz, CDCl₃) δ 8.19 (d, J=3.9 Hz, 2H), 7.97 (s, 2H), 7.82-7.72 (m, 8H), 7.54-7.46 (m, 4H), 7.38 (pd, J=7.4, 1.5 Hz, 4H), 1.59 (s, 12H).

¹³C{¹H} NMR (126 MHz, CDCl₃) δ 154.4, 153.9, 152.7, 146.3, 139.2, 138.7, 138.4, 133.2, 128.6, 127.5, 127.1, 125.8, 125.3, 125.0, 124.0, 122.7, 120.5, 120.1, 120.1, 47.0, 27.2.

HRMS (ESI) m/z calculated for C₄₄H₃₃N₂S₃ (M+1) 685.1800, found 685.1782.

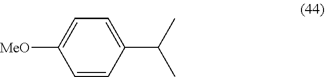

To a mixture of 4-chloroanisole (62 μL, 0.50 mmol, 1 equiv), isopropylboronic acid (66 mg, 0.75 mmol, 1.5 equiv), and K₃PO₄·H₂O (0.35 mg, 1.5 mmol, 3 equiv) was added a toluene stock solution of 3 and PAd₃ (2 mL, 5 mol of Pd/PAd₃). The mixture was stirred at 100° C. for 5 h. The reaction mixture was diluted with ethyl acetate then extracted with water. The combine organic layers were evaporated and the crude product was purified by flash chromatography. After drying, 53 mg (70%) of 44 was obtained as a colorless oil. NMR spectroscopic data agreed with literature values.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A method of cross-coupling comprising:
providing a reaction mixture including a substrate, a coupling partner and a transition metal complex comprising PAd₃ ligand, wherein the coupling partner is an organometallic compound selected from the group consisting of organoboron compounds, organolithium compounds, organozinc compounds, and organosilicon compounds; and
reacting the substrate and the coupling partner in the presence of the transition metal complex to provide cross-coupled reaction product.

2. The method of claim 1, wherein organic moieties of the organometallic compound comprise aromatic moieties.

3. The method of claim 1, wherein organic moieties of the organometallic compound comprise unsaturated aliphatic moieties.

4. The method of claim 1, wherein the transition metal complex is selected from Groups 8-12 of the Periodic Table.

5. The method of claim 4, wherein the transition metal complex is palladium.

6. The method of claim 1, wherein the substrate is a substituted aromatic compound.

7. The method of claim 6, wherein the substituted aromatic compound comprises a leaving group.

8. The method of claim 7, wherein the leaving group is selected from the group consisting of halo, tosylate (OTs), mesylate (OMs), and nosylate (ONs).

9. The method of claim 1, wherein the substrate is a substituted unsaturated aliphatic compound.

10. The method of claim 9, wherein the substituted unsaturated aliphatic compound comprises an allyl or vinyl moiety.

11. The method of claim 1, wherein the transition metal complex is formed in-situ.

12. The method of claim 1, wherein the transition metal complex is added to the reaction mixture.
